(19) United States
(12) Patent Application Publication
(10) Pub. No.: US 2020/0202486 A1
(43) Pub. Date: Jun. 25, 2020

(54) MEDICAL IMAGE PROCESSING APPARATUS, MEDICAL IMAGE PROCESSING METHOD, AND MEDICAL IMAGE PROCESSING PROGRAM

(71) Applicant: FUJIFILM Corporation, Tokyo (JP)

(72) Inventor: Keigo NAKAMURA, Tokyo (JP)

(73) Assignee: FUJIFILM Corporation, Tokyo (JP)

(21) Appl. No.: 16/672,526

(22) Filed: Nov. 4, 2019

(30) Foreign Application Priority Data
Dec. 19, 2018 (JP) 2018-237453

(51) Int. Cl. G06T 3/00; G06T 7/33; G06T 19/20

(52) U.S. Cl. CPC G06T 3/0068; G06T 7/337; G06T 19/20; G06T 2219/2012; G06T 2207/10072; G06T 2207/30012; G06T 2207/20224

(57) ABSTRACT

A difference image generation unit generates a difference image between first and second three-dimensional images. A combining unit generates a composite image in which the difference image is superimposed on at least one of the first three-dimensional image or the second three-dimensional image. A range specifying unit specifies a generation range of the difference image in a direction, in which the tomographic images are arranged, in at least one of the first three-dimensional image or the second three-dimensional image. A display controller displays the composite image on a display unit. In this case, first information indicating a generation range of each of the tomographic images and second information indicating the generation range of the difference image are displayed.

### CROSS-REFERENCE TO RELATED APPLICATIONS

The present application claims priority under 35 U.S.C. § 119 to Japanese Patent Application No. 2018-237453, filed on Dec. 19, 2018. Each of the above application(s) is hereby expressly incorporated by reference, in its entirety, into the present application.

### BACKGROUND OF THE INVENTION

### 1. Field of the Invention

The present disclosure relates to a medical image processing apparatus, a medical image processing method, and a medical image processing program for generating a difference image showing a difference between two three-dimensional images.

### 2. Description of the Related Art

Various methods for generating a temporal difference image from two images captured by two-dimensional simple X-rays at different imaging times or two three-dimensional computed tomography (CT) images or magnetic resonance imaging (MRI) images, each of which includes a plurality of tomographic images, have been proposed. By generating such a temporal difference image, it becomes easy to find a lesion having a small contrast and size. In addition, in a three-dimensional image including a plurality of tomographic images, it is possible to reduce the time and effort for registration between temporal images and the time and effort for observing temporal images while going back and forth.

On the other hand, in a case where the imaging range, imaging conditions (slice interval and the like), and the state of the organ that is a subject are different between two images, it is very time-consuming to perform manual registration between the images and compare the tomographic images one by one.

For this reason, methods for performing registration between two images with high accuracy have been proposed. For example, JP2017-063936A has proposed a method of identifying a plurality of bone parts included in two images, associating each bone part included in one image with each bone part included in the other image, performing registration processing between images of the associated bone parts, generating a difference image between the two images subjected to the registration processing, and superimposing the difference image on one of the two images.

In addition, JP2012-095791A has proposed a method of displaying a range where registration between two images is performed on a difference image. By using the method described in JP2012-095791A, it is possible to easily recognize in which range of the difference image the difference has been taken.

### SUMMARY OF THE INVENTION

Here, in the case of generating a difference image using CT images, the imaging range may be different between two CT images. For example, in CT images of the spine, one CT image may include the entire spine, while the other CT image may include only the lumbar vertebra. In such a case, a difference image is not generated for a tomographic image including a vertebra other than the lumbar vertebra in the CT image. On the other hand, in a case where the difference image is superimposed on one CT image, for a tomographic image of the tomographic plane where no abnormality, such as a lesion, is present in the two CT images, no abnormal region is observed even though the difference image is superimposed on the CT image. For this reason, for a tomographic image on which the difference image is not superimposed, it cannot be seen whether the difference image is not superimposed since there is no abnormality even though the difference image has been generated or the difference image itself has not been generated since the imaging ranges of the two CT images are different.

In the method described in JP2012-095791A, a registration range in one image is displayed. For this reason, for a difference image between three-dimensional images each including a plurality of tomographic images, such as the above CT images, it cannot be seen for which tomographic images the difference image is generated unless individual tomographic images are displayed.

The disclosure has been made in view of the above circumstances, and an object of the disclosure is to make it possible to easily recognize the generation range of a difference image between three-dimensional images each including a plurality of tomographic images, such as CT images, in the case of generating a difference image between the three-dimensional images.

A first medical image processing apparatus according to the disclosure comprises: a registration unit that performs registration between structures included in a first three-dimensional image and a second three-dimensional image, each of which includes a plurality of tomographic images including the same subject and which have different imaging times; a difference image generation unit that generates a difference image between the first three-dimensional image and the second three-dimensional image subjected to the registration processing; a combining unit that generates a composite image in which the difference image is superimposed on at least one of the first three-dimensional image or the second three-dimensional image; a range specifying unit that specifies a generation range of the difference image in a direction, in which the tomographic images are arranged, in at least one of the first three-dimensional image or the second three-dimensional image based on a result of the registration; and a display controller that displays the composite image on a display unit such that first information indicating a generation range of each of the tomographic images and second information indicating the generation range of the difference image in at least one of the first three-dimensional image or the second three-dimensional image are displayed in the composite image.

The difference image and the composite image may be three-dimensional images, or may be two-dimensional images, that is, tomographic images.

In the first medical image processing apparatus according to the disclosure, the first information may be a bar indicating the generation range of each of the tomographic images, and the second information may be a mark indicating a position of a boundary between a generation range and a non-generation range of the difference image in the bar.

In the first medical image processing apparatus according to the disclosure, the display controller may be able to perform switching between display and non-display of the second information.

A second medical image processing apparatus according to the disclosure comprises: a registration unit that performs registration between structures included in a first three-dimensional image and a second three-dimensional image, each of which includes a plurality of tomographic images including the same subject and which have different imaging times; a difference image generation unit that generates a difference image between the first three-dimensional image and the second three-dimensional image subjected to the registration processing; a combining unit that generates a composite image in which the difference image is superimposed on at least one of the first three-dimensional image or the second three-dimensional image; and an information adding unit that adds difference generation information indicating presence or absence of use for generation of the difference image to the composite image based on a result of the registration.

In the second medical image processing apparatus according to the disclosure, the difference generation information may be a mark indicating that there has been use for generation of the difference image or there has been no use for generation of the difference image.

The second medical image processing apparatus according to the disclosure may further comprise a display controller that displays the composite image on a display unit.

In the second medical image processing apparatus according to the disclosure, the display controller may be able to perform switching between display and non-display of the difference generation information.

In the first and second medical image processing apparatuses according to the disclosure, the combining unit may generate the composite image by converting the difference image into a color corresponding to a signal value of the difference image and superimposing the converted difference image on at least one of the first three-dimensional image or the second three-dimensional image.

In this case, the combining unit may convert the difference image into a color corresponding to a signal value of the difference image with reference to a look-up table in which a relationship between a signal value of the difference image and a color is defined.

In the first and second medical image processing apparatuses according to the disclosure, the structure may be a bone.

In this case, the structure may be a vertebra.

In addition, in this case, each of the first three-dimensional image and the second three-dimensional image may include a plurality of tomographic images of an axial cross section.

A first medical image processing method according to the disclosure comprises: performing registration between structures included in a first three-dimensional image and a second three-dimensional image, each of which includes a plurality of tomographic images including the same subject and which have different imaging times; generating a difference image between the first three-dimensional image and the second three-dimensional image subjected to the registration processing; generating a composite image in which the difference image is superimposed on at least one of the first three-dimensional image or the second three-dimensional image; specifying a generation range of the difference image in a direction, in which the tomographic images are arranged, in at least one of the first three-dimensional image or the second three-dimensional image based on a result of the registration; and displaying the composite image on a display unit such that first information indicating a generation range of each of the tomographic images and second information indicating the generation range of the difference image in at least one of the first three-dimensional image or the second three-dimensional image are displayed in the composite image.

A second medical image processing method according to the disclosure comprises: performing registration between structures included in a first three-dimensional image and a second three-dimensional image, each of which includes a plurality of tomographic images including the same subject and which have different imaging times; generating a difference image between the first three-dimensional image and the second three-dimensional image subjected to the registration processing; generating a composite image in which the difference image is superimposed on at least one of the first three-dimensional image or the second three-dimensional image; and adding difference generation information indicating presence or absence of use for generation of the difference image to the composite image based on a result of the registration.

In addition, a program causing a computer to execute the first and second medical image processing methods according to the disclosure may be provided.

A third medical image processing apparatus according to the disclosure comprises: a memory that stores commands to be executed by a computer; and a processor configured to execute the stored commands. The processor executes processing for performing registration between structures included in a first three-dimensional image and a second three-dimensional image, each of which includes a plurality of tomographic images including the same subject and which have different imaging times, generating a difference image between the first three-dimensional image and the second three-dimensional image subjected to the registration processing, generating a composite image in which the difference image is superimposed on at least one of the first three-dimensional image or the second three-dimensional image, specifying a generation range of the difference image in a direction, in which the tomographic images are arranged, in at least one of the first three-dimensional image or the second three-dimensional image based on a result of the registration, and displaying the composite image on a display unit such that first information indicating a generation range of each of the tomographic images and second information indicating the generation range of the difference image in at least one of the first three-dimensional image or the second three-dimensional image are displayed in the composite image.

A fourth medical image processing apparatus according to the disclosure comprises: a memory that stores commands to be executed by a computer; and a processor configured to execute the stored commands. The processor executes processing for performing registration between structures included in a first three-dimensional image and a second three-dimensional image, each of which includes a plurality of tomographic images including the same subject and which have different imaging times, generating a difference image between the first three-dimensional image and the second three-dimensional image subjected to the registration processing, generating a composite image in which the difference image is superimposed on at least one of the first three-dimensional image or the second three-dimensional image, and adding difference generation information indicating presence or absence of use for generation of the difference image to the composite image based on a result of the registration.

According to the first and second medical image processing apparatuses, the first and second medical image processing methods, and the medical image processing program of the disclosure, it is possible to easily recognize the generation range of a difference image in a three-dimensional image.

### BRIEF DESCRIPTION OF THE DRAWINGS

FIG. 1 is a diagram showing the schematic configuration of a diagnostic support system to which a medical image processing apparatus according to a first embodiment of the disclosure is applied.

FIG. 2 is a diagram showing the schematic configuration of the medical image processing apparatus according to the first embodiment.

FIG. 3 is a diagram in which associated vertebral regions are connected by arrows between a first three-dimensional image and a second three-dimensional image.

FIG. 4 is a diagram showing a difference image of a tomographic image.

FIG. 5 is a diagram showing a composite image of tomographic images.

FIG. 6 is a diagram illustrating the generation range of a difference image in a first three-dimensional image.

FIG. 7 is a diagram illustrating the generation range of a difference image in a first three-dimensional image.

FIG. 8 is a diagram showing a composite image in which a bar and marks are displayed.

FIG. 9 is a diagram showing a composite image in which a bar and marks are displayed.

FIG. 10 is a diagram showing a state in which the composite image shown in FIG. 8 and a composite image of a sagittal cross section are displayed side by side.

FIG. 11 is a flowchart showing the process performed in the first embodiment.

FIG. 12 is a diagram showing the schematic configuration of a medical image processing apparatus according to a second embodiment.

FIG. 13 is a diagram showing a composite image to which difference generation information is added.

FIG. 14 is a flowchart showing the process performed in the second embodiment.

FIG. 15 is a diagram showing a state in which a compression fracture has occurred.

FIG. 16 is a diagram showing a composite image in which a bar and marks are displayed in a state in which a compression fracture has occurred.

### DESCRIPTION OF THE PREFERRED EMBODIMENTS

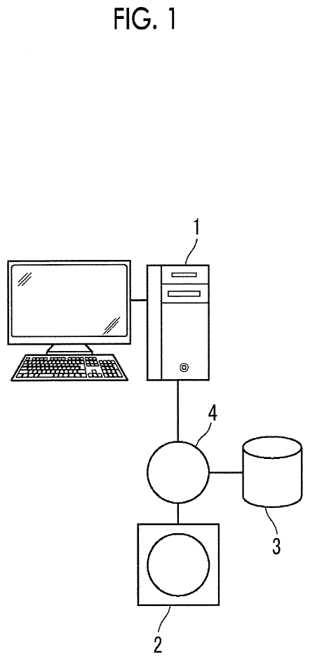

Hereinafter, embodiments of the disclosure will be described with reference to the diagrams. FIG. 1 is a hardware configuration diagram showing the outline of a diagnostic support system to which a medical image processing apparatus according to a first embodiment of the disclosure is applied. As shown in FIG. 1, in the diagnostic support system, a medical image processing apparatus 1 according to the first embodiment, a three-dimensional image capturing apparatus 2, and an image storage server 3 are communicably connected to each other through a network 4.

The three-dimensional image capturing apparatus 2 is an apparatus that generates a three-dimensional image showing a part, which is an examination target part of a patient, as a medical image by imaging the part. Specifically, the three-dimensional image capturing apparatus 2 is a CT apparatus, an MRI apparatus, a positron emission tomography (PET) apparatus, or the like. The medical image generated by the three-dimensional image capturing apparatus 2 is transmitted to the image storage server 3 and is stored therein. In the present embodiment, the diagnostic target part of the patient is a spinal column, the three-dimensional image capturing apparatus 2 is a CT apparatus, and a CT image including a plurality of tomographic images including the spinal column as a subject is generated as a three-dimensional image. In the present embodiment, the cross section of the tomographic image is an axial cross section, but may be a sagittal cross section or a coronal cross section without being limited thereto.

The image storage server 3 is a computer that stores and manages various kinds of data, and comprises a large-capacity external storage device and software for database management. The image storage server 3 communicates with other devices through the wired or wireless network 4 to transmit and receive image data or the like. Specifically, the image storage server 3 acquires various kinds of data including image data of the medical image, which is generated by the three-dimensional image capturing apparatus 2, through the network, and stores the acquired data in a recording medium, such as a large-capacity external storage device, to manage the acquired data. The storage format of image data and the communication between devices through the network 4 are based on a protocol, such as a digital imaging and communication in medicine (DICOM). In the present embodiment, it is assumed that image data of a plurality of three-dimensional images relevant to the spinal column, which has different imaging dates and times for the same patient, are stored in the image storage server 3.

The medical image processing apparatus 1 is realized by installing a medical image processing program according to the first embodiment on one computer. The computer may be a workstation or a personal computer that is directly operated by a doctor who performs diagnosis, or may be a server computer connected to these through a network. The medical image processing program is distributed in a state in which the medical image processing program is recorded on a recording medium, such as a digital versatile disc (DVD) or a compact disc read only memory (CD-ROM), and is installed onto the computer from the recording medium. Alternatively, the medical image processing program is stored in a storage device of a server computer connected to the network or in a network storage so as to be accessible from the outside, and is downloaded and installed onto a computer used by a doctor as necessary.

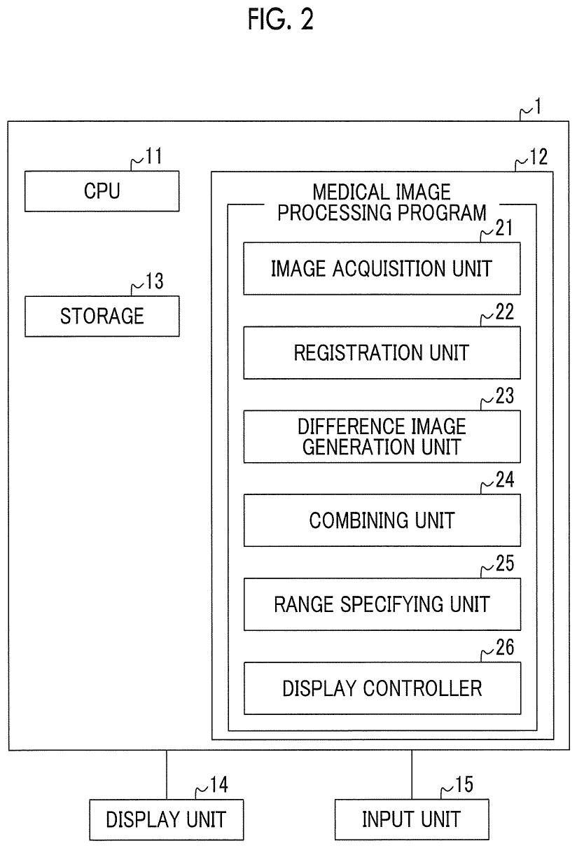

FIG. 2 is a diagram showing the schematic configuration of a medical image processing apparatus realized by installing and executing a medical image processing program according to the first embodiment on a computer. As shown in FIG. 2, the medical image processing apparatus 1 comprises a central processing unit (CPU) 11, a memory 12, and a storage 13 as the configuration of a standard workstation. A display unit 14, such as a liquid crystal display, and an input unit 15, such as a keyboard and a mouse, are connected to the medical image processing apparatus 1.

The storage 13 is a recording medium, such as a hard disk drive or a solid state drive (SSD), and stores a plurality of three-dimensional images having different imaging dates and times for the same subject and various kinds of information including information necessary for processing, which are acquired from the image storage server 3 through the network 4.

A medical image processing program is stored in the memory 12. As processing to be executed by the CPU 11, the medical image processing program defines: image acquisition processing for acquiring a first three-dimensional image V1 and a second three-dimensional image V2, each of which includes a plurality of tomographic images including the same subject and which have different imaging times; registration processing for performing registration between structures included in the first three-dimensional image V1 and the second three-dimensional image V2; difference image generation processing for generating a difference image between the first three-dimensional image V1 and the second three-dimensional image V2 subjected to the registration processing; combining processing for generating a composite image in which the difference image is superimposed on at least one of the first three-dimensional image V1 or the second three-dimensional image V2; range specifying processing for specifying a generation range of the difference image in a direction, in which the tomographic images are arranged, in at least one of the first three-dimensional image V1 or the second three-dimensional image V2 based on the registration result; and display control processing for displaying the composite image on the display unit 14 so that first information indicating a tomographic image generation range and second information indicating a difference image generation range in at least one of the first three-dimensional image V1 or the second three-dimensional image V2 are displayed in the composite image.

The CPU 11 executes these processes according to the program, so that the computer functions as an image acquisition unit 21, a registration unit 22, a difference image generation unit 23, a combining unit 24, a range specifying unit 25, and a display controller 26.

The image acquisition unit 21 acquires the first three-dimensional image V1 and the second three-dimensional image V2, each of which includes a plurality of tomographic images including the same subject and which have different imaging times, from the image storage server 3. In a case where the first and second three-dimensional images V1 and V2 are already stored in the storage 13, the image acquisition unit 21 may acquire the first and second three-dimensional images V1 and V2 from the storage 13. A structure as a diagnostic target is included in the first and second three-dimensional images V1 and V2. In the present embodiment, the structure as a diagnostic target is a vertebra. Between the first and second three-dimensional images V1 and V2, the second three-dimensional image V2 is assumed to have a new imaging time.

The registration unit 22 performs registration between spinal column regions included in the first and second three-dimensional images V1 and V2. Here, since the spinal column is configured to include a plurality of vertebrae, the registration unit 22 performs registration between corresponding vertebrae included in the first and second three-dimensional images V1 and V2. In the present embodiment, it is assumed that registration is performed so that the first three-dimensional image V1 matches the second three-dimensional image V2. However, the registration may be performed so that the second three-dimensional image V2 matches the first three-dimensional image V1.

In order to perform registration, first, the registration unit 22 performs processing for identifying a plurality of vertebrae that form the spinal column included in each of the first three-dimensional image V1 and the second three-dimensional image V2. As processing for identifying the vertebra, it is possible to use known methods, such as a method using a morphological operation, a region expansion method based on a seed point, and a method described in JP2009-207727A.

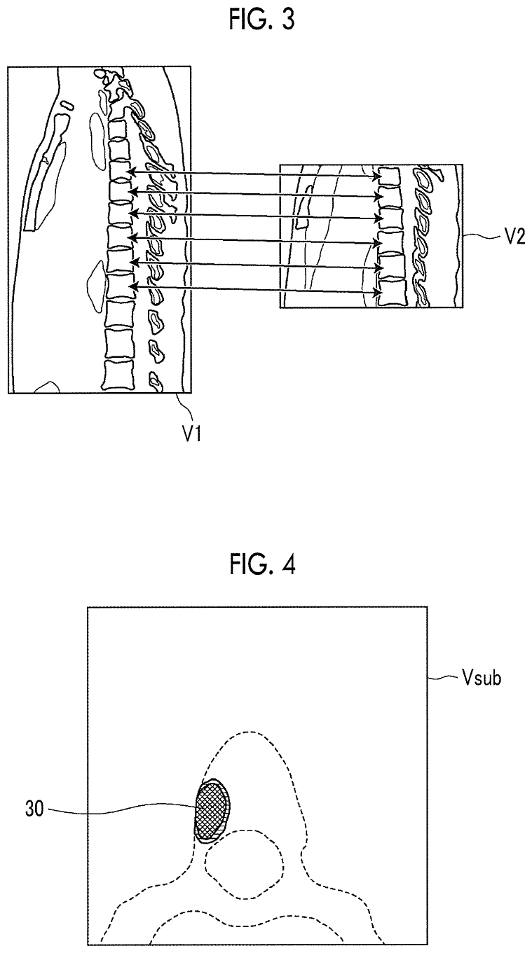

The registration unit 22 associates each vertebral region included in the first three-dimensional image V1 with each vertebral region included in the second three-dimensional image V2. Specifically, a correlation value is calculated for all combinations of vertebral regions between the first three-dimensional image V1 and the second three-dimensional image V2 using the signal value (for example, CT value) of each vertebral region. Then, in a case where the correlation value is equal to or greater than a threshold value set in advance, it is determined that the combination of vertebral regions having the correlation value is a combination for association. The correlation value may be calculated using, for example, normalized cross correlation. However, the method of calculating the correlation value is not limited to the normalized cross correlation, and other calculation methods may be used. FIG. 3 is a diagram in which associated vertebral regions are connected by arrows between the first three-dimensional image V1 and the second three-dimensional image V2.

In FIG. 3, each of the first three-dimensional image V1 and the second three-dimensional image V2 is deformed so that the center line of the spinal column is a straight line. In the present embodiment, it is assumed that the direction of the center line of the spinal column deformed into a straight line is an axial direction and the cross section perpendicular to the center line is an axial cross section. In the present embodiment, it is assumed that the range of the axial direction in which the second three-dimensional image V2 is generated is narrower than the range of the axial direction where the first three-dimensional image V1 is generated.

Then, the registration unit 22 performs image registration processing between the vertebral regions associated with each other as shown in FIG. 3 for each combination of vertebral regions. As a registration method, for example, a method described in JP2017-063936A may be used. The method described in JP2017-063936A is a method of setting a plurality of landmarks for each vertebral region included in each of the first and second three-dimensional images V1 and V2, performing registration by moving the vertebral regions so that the distance between the corresponding landmarks becomes the shortest, and performing rigid body registration processing and non-rigid body registration processing. As the rigid body registration processing, for example, processing using an iterative closest point (ICP) method can be used. However, other methods may be used. As the non-rigid body registration processing, for example, processing using a free-form deformation (FFD) method or processing using a thin-plate spline (TPS) method can be used. However, other methods may be used.

The registration method is not limited thereto. For example, only rigid body registration processing or only non-rigid body registration processing may be performed.

The difference image generation unit 23 generates a difference image Vsub between the first three-dimensional image V1 and the second three-dimensional image V2 registrated by the registration unit 22. Specifically, the difference image Vsub is generated by calculating a difference value between signal values in the corresponding pixels between the corresponding vertebral regions included in the first and second three-dimensional images V1 and V2 subjected to the registration processing. In the present embodiment, the difference image Vsub is generated by subtracting the signal value of the first three-dimensional image V1 from the signal value of the second three-dimensional image V2. However, the disclosure is not limited thereto. The difference image Vsub may be generated by subtracting the signal value of the second three-dimensional image V2 from the signal value of the first three-dimensional image V1. The difference image Vsub generated in this manner is an image in which a lesion such as a bone metastasis of cancer, which is not present in the first three-dimensional image V1 captured in the past but is present in the second three-dimensional image V2, is emphasized. The generation of the difference image Vsub may be performed in a three-dimensional image, but may be performed between tomographic images on the corresponding tomographic plane.

FIG. 4 is a diagram showing a difference image between tomographic images. FIG. 4 shows the difference image Vsub generated from tomographic images including one cross section of a certain vertebra included in the first and second three-dimensional images V1 and V2. Here, in a case where the disease progresses after the first three-dimensional image V1 is acquired and abnormality appears in the second three-dimensional image V2, a region where the signal value is 0 and a region where the signal value is not 0 are included in the difference image Vsub as shown in FIG. 4. In FIG. 4, different hatching according to the signal value is given to an abnormal region 30 where the signal value is not 0. In FIG. 4, the contour line of the vertebra is shown by a broken line.

In a case where the abnormal region is represented by a signal value larger than the normal region in the three-dimensional image, the abnormal region 30 in the difference image Vsub has a larger signal value than other regions. On the other hand, in a case where the abnormal region is represented by a signal value smaller than the normal region in the three-dimensional image, the abnormal region 30 in the difference image Vsub has a smaller (that is, negative) signal value than other regions.

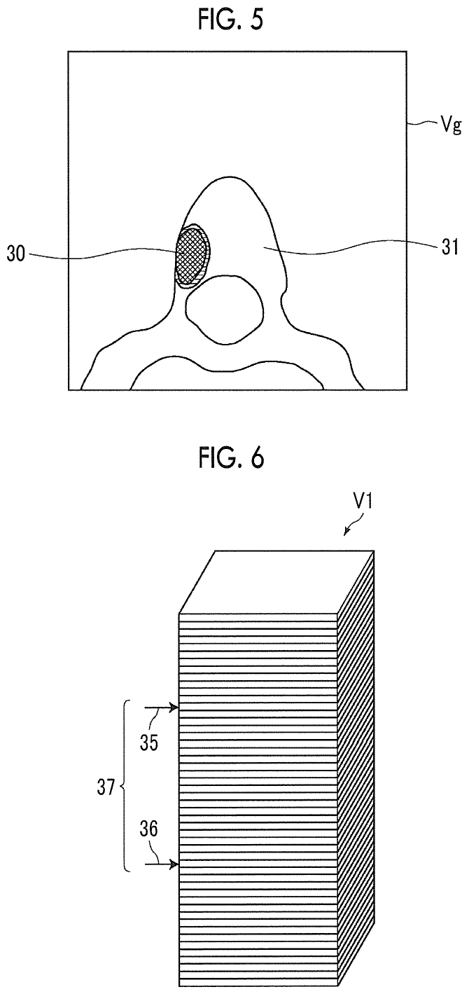

The combining unit 24 generates a composite image Vg in which the difference image Vsub is superimposed on at least one of the first three-dimensional image V1 or the second three-dimensional image V2. Although the composite image Vg in which the difference image Vsub is superimposed on the first three-dimensional image V1 is generated in the present embodiment, the disclosure is not limited thereto. FIG. 5 is a diagram showing a composite image. As shown in FIG. 5, in the composite image Vg, the abnormal region 30 included in the difference image Vsub is superimposed on a vertebra 31 included in the first three-dimensional image V1. The combining unit 24 generates a color image by assigning a preset color to the difference image Vsub, and generates the composite image Vg by superimposing the color image on the first three-dimensional image V1 that is a monochrome image.

In the present embodiment, a look-up table for converting the signal value of the difference image Vsub into a color corresponding to the signal value is stored in the storage 13. The combining unit 24 converts the signal value of the difference image Vsub into a color with reference to the look-up table stored in the storage 13. The conversion of the signal value of the difference image Vsub into a color is not limited to that using a look-up table. For example, the signal value of the difference image Vsub may be converted into a color using a mathematical expression for converting the signal value into a color.

The range specifying unit 25 specifies the generation range of the difference image Vsub in a direction, in which the tomographic images are arranged, in at least one of the first three-dimensional image V1 or the second three-dimensional image V2 based on the registration result. In the present embodiment, as shown in FIG. 3, the range in the axial direction of the second three-dimensional image V2 is narrower than the range in the axial direction of the first three-dimensional image V1. For this reason, the difference image Vsub is generated only in the range where the second three-dimensional image V2 is present between the first three-dimensional image V1 and the second three-dimensional image V2. The range specifying unit 25 specifies the generation range of the difference image Vsub with the first three-dimensional image V1, on which the difference image Vsub is superimposed, as a reference.

FIG. 6 is a diagram illustrating the generation range of the difference image Vsub in the first three-dimensional image V1. As shown in FIG. 6, in a case where the difference image Vsub is generated in a range 37 interposed between two arrows 35 and 36 among a plurality of tomographic images forming the first three-dimensional image V1, the range 37 in the first three-dimensional image V1 is specified as the generation range of the difference image Vsub. Here, assuming that the generation of the first and second three-dimensional images V1 and V2 is started from the upper side of FIG. 6, that is, from the head side in the three-dimensional image capturing apparatus 2, the position of the arrow 35 corresponds to the position of the first tomographic image in the difference image generation range in the second three-dimensional image V2. In addition, the position of the arrow 36 corresponds to the position of the last tomographic image in the difference image generation range in the second three-dimensional image V2.

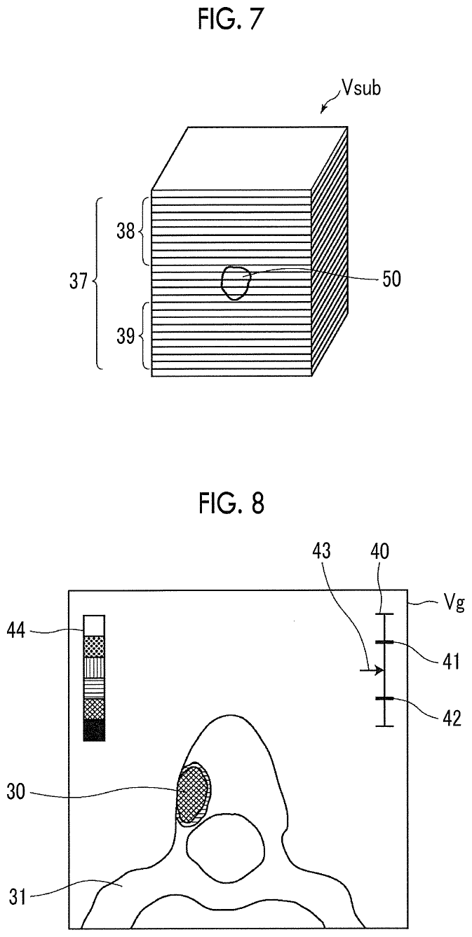

Here, for a region where there is no abnormality in both the first three-dimensional image V1 and the second three-dimensional image V2, even in a case where the difference image Vsub is generated, the signal value of the difference image Vsub becomes 0. For this reason, even in a case where the composite image Vg is generated using such a difference image Vsub, no abnormal region is included in the composite image Vg. For example, as shown in FIG. 7, it is assumed that the difference image Vsub is generated in the range 37 in the first three-dimensional image V1 and an abnormal region 50 is included in the difference image Vsub. In this case, in the range 37 where the difference image Vsub is generated, ranges 38 and 39 not including the abnormal region 50 are included. For this reason, no abnormal region is included in the composite image Vg generated from the difference image Vsub in the ranges 38 and 39. Therefore, it cannot be seen whether there is no abnormality or the difference image Vsub is not generated originally by observing the composite image Vg.

For this reason, the display controller 26 displays the composite image Vg on the display unit 14 and displays, in the displayed composite image Vg, first information indicating the generation range of a tomographic image and second information indicating the generation range of the difference image Vsub in at least one of the first three-dimensional image V1 or the second three-dimensional image V2. In the present embodiment, a bar indicating the generation range of a tomographic image in the first three-dimensional image V1 having a wide tomographic image generation range is displayed as the first information, and marks indicating the position of the boundary between the generation range and the non-generation range of a difference image on the bar are used as the second information.

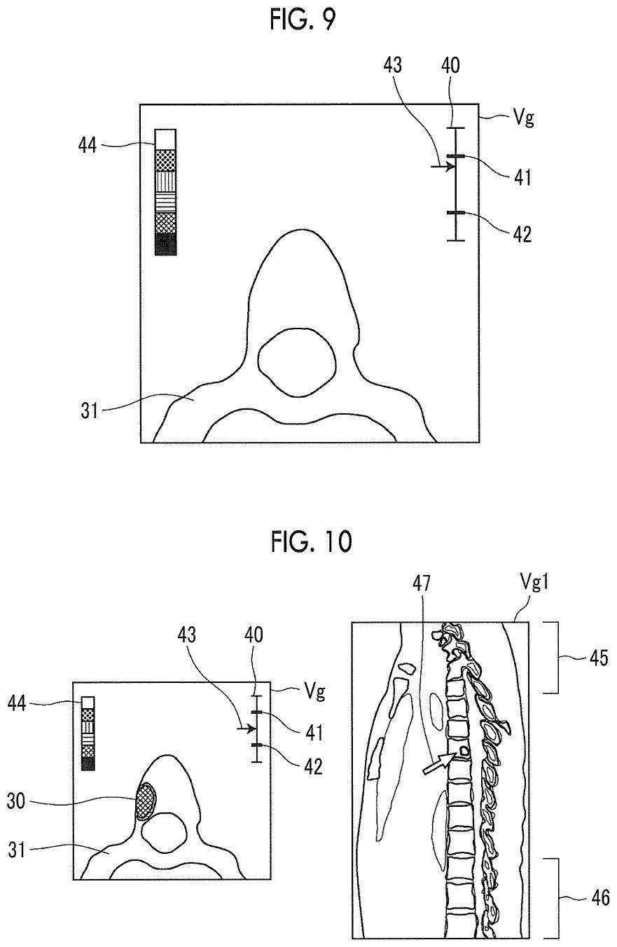

FIGS. 8 and 9 are diagrams showing a composite image in which a bar and marks are displayed. As shown in FIGS. 8 and 9, a bar 40 is displayed at the upper right position of the composite image Vg, and marks 41 and 42 indicating the position of the boundary between the generation range and the non-generation range of the difference image Vsub are displayed on the bar 40. The positions of the marks 41 and 42 on the bar 40 may be proportional to the positions of arrows 35 and 36 with respect to the entire range of the first three-dimensional image V1 shown in FIG. 6. In addition, an arrow 43 indicating the position of the currently displayed composite image is also displayed on the bar 40. In addition, a reference 44 indicating the degree of abnormality according to the color of the difference image Vsub is also displayed.

In FIG. 8, since the abnormal region 30 is included in the composite image Vg, it can be confirmed by the presence of the abnormal region 30 that the difference image Vsub has been generated. In addition, it can also be confirmed by the bar 40 and the marks 41 and 42 that the difference image Vsub has been generated. Even in a case where the abnormal region 30 is not included in the composite image Vg, it can be confirmed that the difference image Vsub has been generated by observing the bar 40 and the marks 41 and 42 and the position of the arrow 43. In the composite image Vg shown in FIG. 9, since the arrow 43 indicates between the marks 41 and 42 on the bar 40, it can be confirmed that the difference image Vsub has been generated.

In addition to the composite image Vg, a composite image Vg1 in which a difference image is superimposed on a tomographic image of a sagittal cross section passing through the spine in the first three-dimensional image V1 may be generated. In this case, as shown in FIG. 10, the composite image Vg shown in FIG. 8 and a composite image Vg1 of the sagittal cross section may be displayed side by side. An arrow 47 indicating an abnormal region is given to the composite image Vg1 shown in FIG. 10. Marks 45 and 46 indicating a range where no difference image is generated are displayed on the right side of the composite image Vg1 shown in FIG. 10. Needless to say, a mark may be displayed in a range where the difference image Vsub is generated in the composite image Vg1.

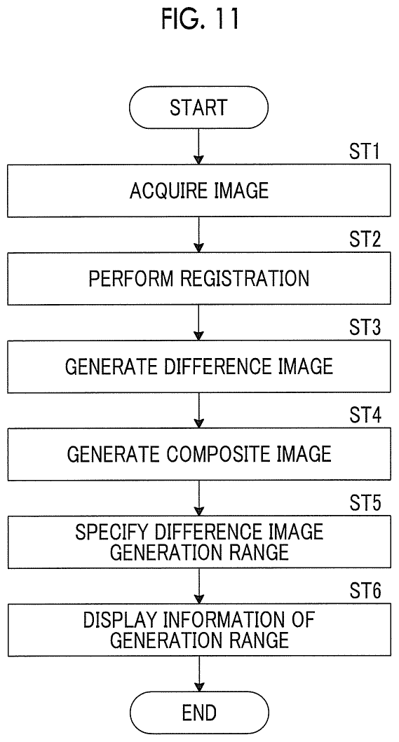

Next, the process performed in the first embodiment will be described. FIG. 11 is a flowchart showing the process performed in the first embodiment. The process is started in response to an instruction to create a composite image, and the image acquisition unit 21 acquires the first three-dimensional image V1 and the second three-dimensional image V2 each of which includes a plurality of tomographic images including the same subject and which have different imaging times (image acquisition; step ST1). Then, the registration unit 22 performs registration between structures, that is, vertebrae included in the first three-dimensional image V1 and the second three-dimensional image V2 (step ST2). Then, the difference image generation unit 23 generates the difference image Vsub between the first three-dimensional image V1 and the second three-dimensional image V2 subjected to the registration processing (step ST3).

Then, the combining unit 24 generates the composite image Vg in which the difference image Vsub is superimposed on at least one of the first three-dimensional image V1 or the second three-dimensional image V2 (step ST4). Then, the range specifying unit 25 specifies the generation range of the difference image Vsub in a direction, in which tomographic images are arranged, in at least one of the first three-dimensional image V1 or the second three-dimensional image V2 based on the registration result (step ST5). Then, the display controller 26 displays the composite image Vg on the display unit 14 and displays, in the composite image Vg, the bar 40 indicating the generation range of a tomographic image and the marks 41 and 42 indicating the generation range of the difference image in at least one of the first three-dimensional image V1 or the second three-dimensional image V2 (generation range information display; step ST6), and the process is ended.

As described above, according to the first embodiment, the first information indicating the generation range of the tomographic image and the second information indicating the generation range of the difference image Vsub in at least one of the first three-dimensional image V1 or the second three-dimensional image V2 are displayed in the composite image Vg. For this reason, the generation range of the difference image Vsub in the generation range of the tomographic image can be easily recognized from the first information and the second information that are displayed. Therefore, in a case where the difference image Vsub is not superimposed on the displayed composite image Vg, it can be easily checked whether there is no abnormality or the difference image Vsub is not generated by checking the first information and the second information. As a result, it is possible to easily recognize the range where the difference image Vsub is generated in the three-dimensional image.

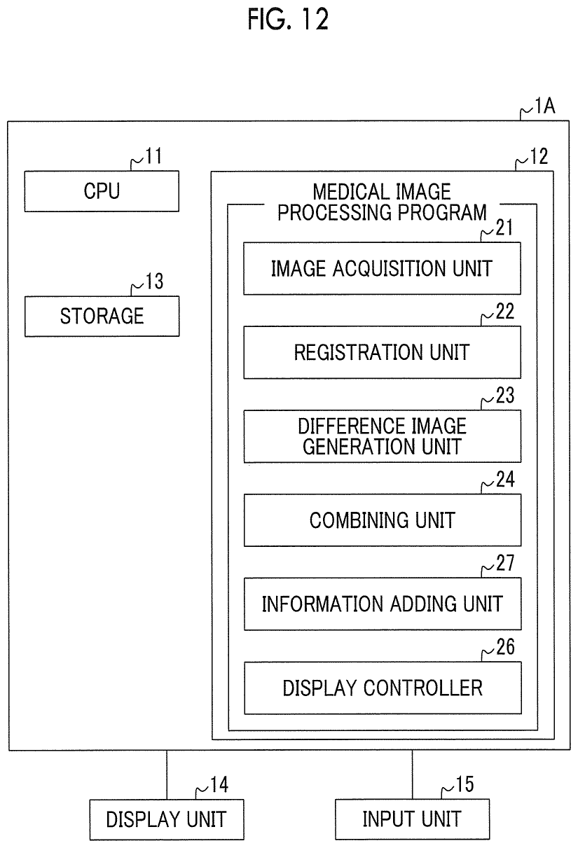

Next, a second embodiment of the disclosure will be described. FIG. 12 is a diagram showing the schematic configuration of a medical image processing apparatus realized by installing and executing a medical image processing program according to the second embodiment on a computer. In FIG. 12, the same components as in FIG. 2 are denoted by the same reference numerals, and the detailed description thereof will be omitted. A medical image processing apparatus 1A according to the second embodiment is different from the medical image processing apparatus 1 according to the first embodiment in that the medical image processing apparatus 1A comprises an information adding unit 27 that adds difference generation information indicating the presence or absence of use for generation of the difference image Vsub to the composite image Vg based on a registration result instead of the range specifying unit 25 in the first embodiment.

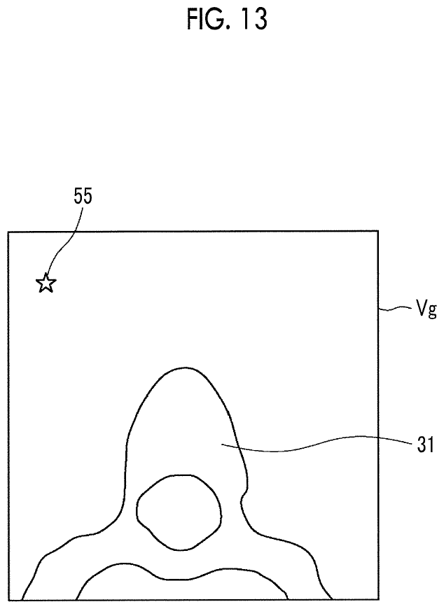

In the second embodiment, the information adding unit 27 adds difference generation information to the composite image Vg in which a difference image is generated. FIG. 13 is a diagram showing a composite image to which difference generation information is added. Whether or not the difference image Vsub has been generated can be determined by determining whether or not the second three-dimensional image V2 is present at the corresponding position of the first three-dimensional image V1 as a result of registration. As shown in FIG. 13, no abnormal region is included in the composite image Vg, but difference generation information 55 is added to the composite image Vg. Although the difference generation information is a star mark in FIG. 13, the difference generation information is not limited thereto. The difference generation information may be a mark of another shape, or may be a text indicating that a difference image has been generated.

In addition, although the difference generation information 55 may be added only to the composite image Vg including no abnormal region, the difference generation information 55 may be added to all the composite images Vg in which the difference image Vsub has been generated.

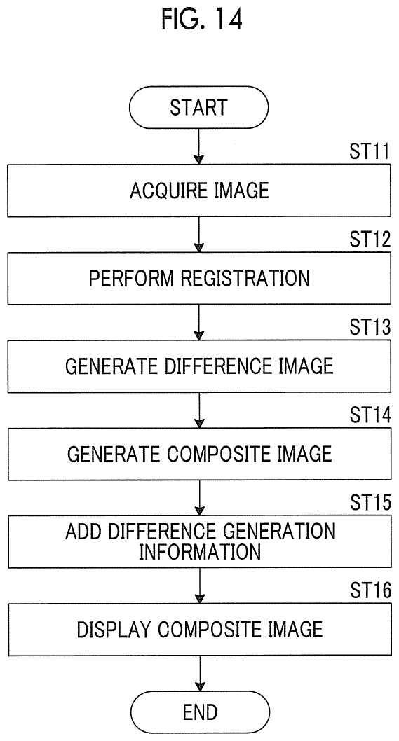

Next, the process performed in the second embodiment will be described. FIG. 14 is a flowchart showing the process performed in the second embodiment. The process is started in response to an instruction to create a composite image, and the image acquisition unit 21 acquires the first three-dimensional image V1 and the second three-dimensional image V2 each of which includes a plurality of tomographic images including the same subject and which have different imaging times (image acquisition; step ST11). Then, the registration unit 22 performs registration between structures included in the first three-dimensional image V1 and the second three-dimensional image V2 (step ST12). Then, the difference image generation unit 23 generates the difference image Vsub between the first three-dimensional image V1 and the second three-dimensional image V2 subjected to the registration processing (step ST13).

Then, the combining unit 24 generates the composite image Vg in which the difference image Vsub is superimposed on at least one of the first three-dimensional image V1 or the second three-dimensional image V2 (step ST14). Then, the information adding unit 27 adds difference generation information indicating the presence or absence of use for generation of the difference image Vsub to the composite image Vg based on the registration result (step ST15). Then, the display controller 26 displays the composite image Vg on the display unit 14 (step ST16), and the process is ended.

As described above, in the second embodiment, the difference generation information 55 indicating the presence or absence of use for generation of the difference image Vsub is added to the composite image Vg based on the registration result. Therefore, in a case where an abnormal region based on the difference image Vsub is not included in the displayed composite image Vg, it can be easily checked whether there is no abnormality or the difference image Vsub is not generated by the presence or absence of the difference generation information 55. As a result, it is possible to easily recognize the range where the difference image Vsub is generated in the three-dimensional image.

In the above embodiments, the structure as a diagnostic target included in each of the first three-dimensional image V1 and the second three-dimensional image V2 is a vertebra, but is not limited thereto. The structure may be an organ other than the vertebra, for example, lung, liver, heart, kidney, or brain. Alternatively, the structure may be a bronchus, a blood vessel, and the like included in the organ.

On the other hand, there may be a case where a difference image cannot be generated due to occurrence of a compression fracture or the like in a tomographic image for which the difference image Vsub is to be generated. For example, as shown in FIG. 15, in a case where a compression fracture occurs in a vertebra 32 in the second three-dimensional image V2, a difference image cannot be generated at the position of the vertebra 32. For this reason, in the first embodiment described above, it is preferable to display more clearly a range where the difference image Vsub is not generated in the bar and marks displayed in the composite image Vg.

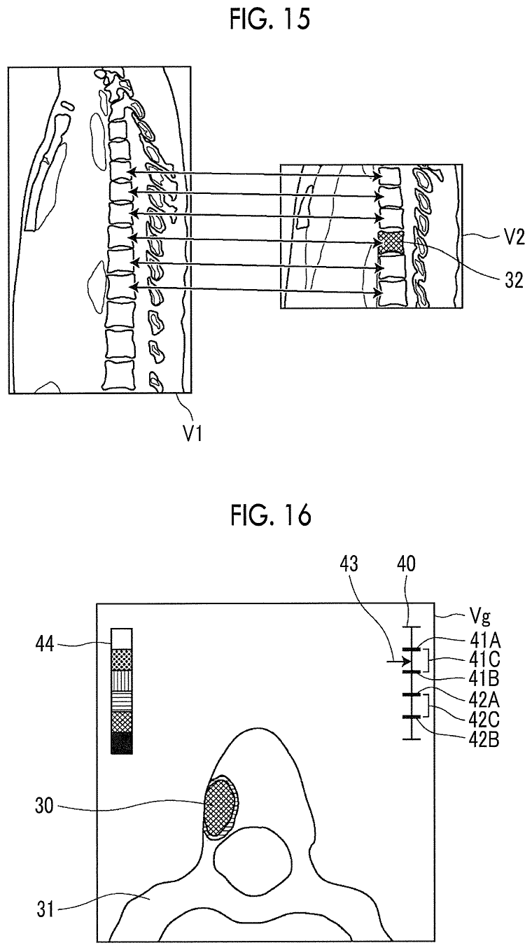

FIG. 16 is a diagram showing a composite image in which a bar and marks are displayed in a state in which a compression fracture has occurred. In FIG. 16, the same portions as in FIGS. 8 and 9 are denoted by the same reference numerals, and the detailed description thereof will be omitted. In FIG. 16, the bar 40 is displayed at the upper right position of the composite image Vg. Then, on the bar 40, marks 41A and 41B indicating the position of the boundary between the generation range and the non-generation range of the first difference image Vsub as viewed from the upper side of FIG. 16, that is, from the head side are displayed. In addition, marks 42A and 42B indicating the position of the boundary between the generation range and the non-generation range of the second difference image Vsub as viewed from the head side are displayed. In addition, a mark 41C indicating that the difference image Vsub is generated between the marks 41A and 41B and a mark 42C indicating that the difference image Vsub is generated between the marks 42A and 42B are displayed. In addition, an arrow 43 indicating the position of the currently displayed composite image Vg and a reference 44 indicating the degree of abnormality according to the color of the difference image Vsub are displayed. By displaying the bar 40 and the marks 41A to 41C and 42A to 42C as shown in FIG. 16, the generation range of the difference image Vsub can be recognized more accurately.

Also in the second embodiment, in a case where the difference image Vsub is not generated due to compression fracture or the like in a tomographic image for which the difference image Vsub is to be generated, the difference generation information 55 may not be displayed for the composite image Vg of the cross section for which the difference image Vsub is not generated.

In the first embodiment described above, the first information indicating the generation range of the tomographic image and the second information indicating the generation range of the difference image are displayed in the composite image of the tomographic images of the axial cross section. However, the disclosure is not limited thereto. Needless to say, the first information and the second information may be displayed in the composite image of the tomographic images of the sagittal cross section or the coronal cross section.

In the first and second embodiments described above, the display and non-display of the marks 41 and 42 and the difference generation information 55 may be switched by an instruction from the input unit 15. In addition, in the first embodiment described above, the display and non-display of the bar 40 may be switched by an instruction from the input unit 15.

In the embodiments described above, for example, various processors shown below can be used as the hardware structures of processing units for executing various kinds of processing, such as the image acquisition unit 21, the registration unit 22, the difference image generation unit 23, the combining unit 24, the range specifying unit 25, the display controller 26, and the information adding unit 27. The various processors include not only the above-described CPU, which is a general-purpose processor that executes software (program) to function as various processing units, but also a programmable logic device (PLD) that is a processor whose circuit configuration can be changed after manufacture, such as a field programmable gate array (FPGA), and a dedicated electric circuit that is a processor having a circuit configuration that is designed for exclusive use in order to execute specific processing, such as an application specific integrated circuit (ASIC).

One processing unit may be configured by one of various processors, or may be a combination of two or more processors of the same type or different types (for example, a combination of a plurality of FPGAs or a combination of a CPU and an FPGA). Alternatively, a plurality of processing units may be configured by one processor.

As an example of configuring a plurality of processing units using one processor, first, as represented by a computer, such as a client and a server, there is a form in which one processor is configured by a combination of one or more CPUs and software and this processor functions as a plurality of processing units. Second, as represented by a system on chip (SoC) or the like, there is a form of using a processor for realizing the function of the entire system including a plurality of processing units with one integrated circuit (IC) chip. Thus, various processing units are configured by using one or more of the above-described various processors as a hardware structure.

More specifically, as the hardware structure of these various processors, it is possible to use an electrical circuit (circuitry) in which circuit elements, such as semiconductor elements, are combined.

### EXPLANATION OF REFERENCES

1, 1A: medical image processing apparatus
2: three-dimensional image capturing apparatus
3: image storage server
4: network
11: CPU
12: memory
13: storage
14: display unit
15: input unit
21: image acquisition unit
22: registration unit
23: difference image generation unit
24: combining unit
25: range specifying unit
26: display controller
27: information adding unit
30: abnormal region
31, 32: vertebra
35, 36, 43: arrow
37, 38, 39: range
40: bar
41, 41A to 41C, 42, 42A to 42C, 45: mark
44: reference
47: arrow
50: abnormal region
55: difference generation information
V1: first three-dimensional image
V2: second three-dimensional image
Vg: composite image
Vg1: composite image of sagittal cross section
Vsub: difference image

What is claimed is:

1. A medical image processing apparatus, comprising:
a registration unit that performs registration between structures included in a first three-dimensional image and a second three-dimensional image, each of which includes a plurality of tomographic images including the same subject and which have different imaging times;
a difference image generation unit that generates a difference image between the first three-dimensional image and the second three-dimensional image subjected to the registration processing;
a combining unit that generates a composite image in which the difference image is superimposed on at least one of the first three-dimensional image or the second three-dimensional image;
a range specifying unit that specifies a generation range of the difference image in a direction, in which the tomographic images are arranged, in at least one of the first three-dimensional image or the second three-dimensional image based on a result of the registration; and
a display controller that displays the composite image on a display unit such that first information indicating a generation range of each of the tomographic images and second information indicating the generation range of the difference image in at least one of the first three-dimensional image or the second three-dimensional image are displayed in the composite image.

2. The medical image processing apparatus according to claim 1,
wherein the first information is a bar indicating the generation range of each of the tomographic images, and
the second information is a mark indicating a position of a boundary between a generation range and a non-generation range of the difference image in the bar.

3. The medical image processing apparatus according to claim 1,
wherein the display controller is able to perform switching between display and non-display of the second information.

4. A medical image processing apparatus, comprising:
a registration unit that performs registration between structures included in a first three-dimensional image and a second three-dimensional image, each of which includes a plurality of tomographic images including the same subject and which have different imaging times;
a difference image generation unit that generates a difference image between the first three-dimensional image and the second three-dimensional image subjected to the registration processing;
a combining unit that generates a composite image in which the difference image is superimposed on at least one of the first three-dimensional image or the second three-dimensional image; and
an information adding unit that adds difference generation information indicating presence or absence of use for generation of the difference image to the composite image based on a result of the registration.

5. The medical image processing apparatus according to claim 4,
wherein the difference generation information is a mark indicating that there has been use for generation of the difference image or there has been no use for generation of the difference image.

6. The medical image processing apparatus according to claim 4, further comprising:
a display controller that displays the composite image on a display unit.

7. The medical image processing apparatus according to claim 6,
wherein the display controller is able to perform switching between display and non-display of the difference generation information.

8. The medical image processing apparatus according to claim 1,
wherein the combining unit generates the composite image by converting the difference image into a color corresponding to a signal value of the difference image and superimposing the converted difference image on at least one of the first three-dimensional image or the second three-dimensional image.

9. The medical image processing apparatus according to claim 4,
wherein the combining unit generates the composite image by converting the difference image into a color corresponding to a signal value of the difference image and superimposing the converted difference image on at least one of the first three-dimensional image or the second three-dimensional image.

10. The medical image processing apparatus according to claim 8,
wherein the combining unit converts the difference image into a color corresponding to a signal value of the difference image with reference to a look-up table in which a relationship between a signal value of the difference image and a color is defined.

11. The medical image processing apparatus according to claim 9,
wherein the combining unit converts the difference image into a color corresponding to a signal value of the difference image with reference to a look-up table in which a relationship between a signal value of the difference image and a color is defined.

12. The medical image processing apparatus according to claim 1,
wherein the structure is a bone.

13. The medical image processing apparatus according to claim 12,
wherein the structure is a vertebra.

14. The medical image processing apparatus according to claim 13,
wherein each of the first three-dimensional image and the second three-dimensional image includes a plurality of tomographic images of an axial cross section.

15. A medical image processing method using the medical image processing apparatus according to claim 1, the method comprising:
performing registration between structures included in a first three-dimensional image and a second three-dimensional image, each of which includes a plurality of tomographic images including the same subject and which have different imaging times;
generating a difference image between the first three-dimensional image and the second three-dimensional image subjected to the registration processing;
generating a composite image in which the difference image is superimposed on at least one of the first three-dimensional image or the second three-dimensional image;
specifying a generation range of the difference image in a direction, in which the tomographic images are arranged, in at least one of the first three-dimensional image or the second three-dimensional image based on a result of the registration; and
displaying the composite image on a display unit such that first information indicating a generation range of each of the tomographic images and second information indicating the generation range of the difference image in at least one of the first three-dimensional image or the second three-dimensional image are displayed in the composite image.

16. A medical image processing method using the medical image processing apparatus according to claim 4, the method comprising:
performing registration between structures included in a first three-dimensional image and a second three-dimensional image, each of which includes a plurality of tomographic images including the same subject and which have different imaging times;
generating a difference image between the first three-dimensional image and the second three-dimensional image subjected to the registration processing;
generating a composite image in which the difference image is superimposed on at least one of the first three-dimensional image or the second three-dimensional image; and
adding difference generation information indicating presence or absence of use for generation of the difference image to the composite image based on a result of the registration.

17. A non-transitory computer readable recording medium storing a medical image processing program causing a computer to function as the medical image processing apparatus according to claim 1, the function comprising:
a step of performing registration between structures included in a first three-dimensional image and a second three-dimensional image, each of which includes a plurality of tomographic images including the same subject and which have different imaging times;
a step of generating a difference image between the first three-dimensional image and the second three-dimensional image subjected to the registration processing;
a step of generating a composite image in which the difference image is superimposed on at least one of the first three-dimensional image or the second three-dimensional image;
a step of specifying a generation range of the difference image in a direction, in which the tomographic images are arranged, in at least one of the first three-dimensional image or the second three-dimensional image based on a result of the registration; and
a step of displaying the composite image on a display unit such that first information indicating a generation range of each of the tomographic images and second information indicating the generation range of the difference image in at least one of the first three-dimensional image or the second three-dimensional image are displayed in the composite image.

18. A non-transitory computer readable recording medium storing a medical image processing program causing a computer to function as the medical image processing apparatus according to claim 4, the function comprising:
a step of performing registration between structures included in a first three-dimensional image and a second three-dimensional image, each of which includes a plurality of tomographic images including the same subject and which have different imaging times;
a step of generating a difference image between the first three-dimensional image and the second three-dimensional image subjected to the registration processing;
a step of generating a composite image in which the difference image is superimposed on at least one of the first three-dimensional image or the second three-dimensional image; and
a step of adding difference generation information indicating presence or absence of use for generation of the difference image to the composite image based on a result of the registration.

19. A medical image processing apparatus, comprising:
a memory that stores commands to be executed by a computer; and
a processor configured to execute the stored commands,
wherein the processor executes processing for:
performing registration between structures included in a first three-dimensional image and a second three-dimensional image, each of which includes a plurality of tomographic images including the same subject and which have different imaging times,
generating a difference image between the first three-dimensional image and the second three-dimensional image subjected to the registration processing,
generating a composite image in which the difference image is superimposed on at least one of the first three-dimensional image or the second three-dimensional image,
specifying a generation range of the difference image in a direction, in which the tomographic images are arranged, in at least one of the first three-dimensional image or the second three-dimensional image based on a result of the registration, and
displaying the composite image on a display unit such that first information indicating a generation range of each of the tomographic images and second information indicating the generation range of the difference image in at least one of the first three-dimensional image or the second three-dimensional image are displayed in the composite image.

20. A medical image processing apparatus, comprising:
a memory that stores commands to be executed by a computer; and
a processor configured to execute the stored commands,
wherein the processor executes processing for:
performing registration between structures included in a first three-dimensional image and a second three-dimensional image, each of which includes a plurality of tomographic images including the same subject and which have different imaging times,
generating a difference image between the first three-dimensional image and the second three-dimensional image subjected to the registration processing,
generating a composite image in which the difference image is superimposed on at least one of the first three-dimensional image or the second three-dimensional image, and
adding difference generation information indicating presence or absence of use for generation of the difference image to the composite image based on a result of the registration.
